(19) United States
(12) Patent Application Publication
(10) Pub. No.: US 2025/0091317 A1
(43) Pub. Date: Mar. 20, 2025

(54) HYBRID POLYLACTIC ACID AND POLYURETHANE FOAM ARTICLES AND ASSOCIATED METHODS

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/891,347

(22) Filed: Sep. 20, 2024

Related U.S. Application Data
(60) Provisional application No. 63/583,914, filed on Sep. 20, 2023.

(51) Int. Cl. B32B 5/32; B32B 5/14; B32B 5/20

(52) U.S. Cl. CPC B32B 5/32; B32B 5/142; B32B 5/20; B32B 2250/04; B32B 2250/22; B32B 2266/0221; B32B 2266/0264; B32B 2266/0278; B32B 2266/14; B32B 2307/72; B32B 2605/08

(57) ABSTRACT

Hybrid foam articles are provided herein, the articles including at least one layer of expandable polylactic acid (ePLA) foam and at least one layer of polyurethane (PU) foam. It has been unexpectedly discovered that replacing at least a portion of the PU foam with an equivalent volume of ePLA foam can advantageously reduce the weight of the article compared to a PU foam article, increase the flexural strength, improve the recyclability/compostability of the article, reduce the amount of polyurethane foam waste, and simply the manufacturing process of the foam article.

### CROSS-REFERENCE TO RELATED APPLICATION

This application claims priority to U.S. Provisional Patent Application No. 63/583,914, filed Sep. 20, 2023, which is incorporated herein by reference.

### BACKGROUND

Polyurethane (PU) foam is the most widely used polymeric foam around the world. It is used for home insulation, insulation for refrigerators, furniture (sofa, chairs, and mattresses), floor underlay, automotive interiors, antifatigue mats, acoustic management, and protective packaging, to name a few applications.

The use of PU foam is under scrutiny due to the large volume of waste PU foam in waste streams and its inability to degrade or be easily recycled. Physical recycling of PU foam involves breaking the PU foam into small chunks and then gluing it back together, but this recycled PU foam is limited to carpet underlay and a few less critical applications. Chemical PU foam recycling is only feasible for relatively “clean” PU foam and relies on the use of chemicals that require special handling in disposal. Furthermore, the natural decomposition of PU foam is extremely slow.

Current efforts at reducing PU waste involve producing sustainable polyurethane primarily by modifying the raw materials being used for PU foam production. These efforts involve replacing a fraction of the petrochemical based polyols with soya bean oil or other biobased oils. Although this often results in foam containing 5-20% biobased content, the incorporation of the biobased polyols does not improve natural degradation.

Another approach to reducing PU waste involves the formation of so-called “hybrid” foams that involve joining a layer of PU foam to another foam layer. For example, some hybrid foams involve two layers of PU foam having different densities. One commercially available hybrid foam involves a layer of ethylene vinyl alcohol (EVA) foam laminated to a layer of PU foam. The hybrid EVA-PU foam reduces compressibility with the incorporation of an EVA layer. Although this helps reduce PU foam waste, hybrid EVA-PU foams are still petrochemical based and have only nominal weight reduction compared to PU foam alone.

Accordingly, improved foams are needed for overcoming one or more of the technical challenges described above.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the contest, singular and plural terminology may be used interchangeably.

FIG. 1 depicts a PU-EVA hybrid foam article in the prior art.

FIG. 2 depicts a PU-EVA hybrid foam article in the prior art.

FIG. 3 depicts a PU-ePLA hybrid foam article in accordance with the present disclosure.

FIGS. 4A-4C depict a three-layer PU-ePLA hybrid foam article in accordance with the present disclosure.

FIGS. 5A-5D depict a hybrid foam article with a layer of fabric in accordance with the present disclosure.

FIG. 6 depicts a hybrid foam article in accordance with the present disclosure.

FIG. 7A-7B depict a hybrid foam article in accordance with the present disclosure.

FIG. 8A-8B depict a hybrid foam article in accordance with the present disclosure.

FIG. 9 depicts a hybrid foam article in accordance with the present disclosure.

### DETAILED DESCRIPTION

Hybrid foam articles and methods of making hybrid foam articles are disclosed herein including at least one layer of polyurethane (PU) foam and at least one layer of expandable polylactic acid (ePLA) foam. In particular, it has been discovered that the formation of a hybrid foam article with at least one layer of PU foam and at least one layer of ePLA foam advantageously reduces the weight of the final article relative to a PU foam article of the same size while maintaining or improving on the foam's performance for both impact and acoustic applications. Furthermore, the incorporation of ePLA foam results in a hybrid foam article that is at least partially biodegradable.

The ePLA foam may be formed according to the methods described in U.S. Pat. No. 10,518,444 to Lifoam Industries, LLC, U.S. Pat. No. 10,688,698 to Lifoam Industries, LLC, or U.S. Pat. No. 11,213,980 to Lifoam Industries, LLC, each of which are incorporated herein by reference. The ePLA foam may be formed from homopolymers, copolymers, or blend that include polylactic acid. In some embodiments, the ePLA foam includes one or more additives, such as chain extenders, flammability retardants, nucleation agents, blowing agents, or the like.

Polylactic acid-based foam articles are remarkably robust and versatile. For example, as described in U.S. patent application Ser. No. 18/191,422 by Lifoam Industries, LLC, which is hereby incorporated by reference, ePLA foam articles may be formed into highly customizable shapes by thermoforming. By forming at least one layer of ePLA foam and subsequently thermoforming it into a desired shape, at least one layer of PU foam may be applied or formed on the at least one layer of ePLA foam to form the hybrid foam article having the desired shape. This may be accomplished without any waste material because the thermoforming process, unlike subtractive machining, does not require removal of any foam material to produce the desired shape.

Polylactic acid-based foam may also be formed or molded into a remarkably thick article, as described in U.S. patent application Ser. No. 17/656,700 to Lifoam Industries, LLC. This article may be many inches in thickness yet remain low weight, whereas a comparable PU foam article of the same thickness may be twice the weight and incapable of degrading in nature. Ethylene vinyl alcohol (EVA) foam cannot be formed into articles thicker than around 1 inch so multiple EVA layers must be secured together using glue in order to effectively replace at least some of the PU foam in thicker articles.

Polylactic acid-based foam also advantageously enables robust adhesion to PU foam by simply heating the surface of the ePLA foam, as described in U.S. patent application Ser. No. 18/477,183 to Lifoam Industries, LLC, which is hereby incorporated by reference. Thus, the at least one layer of ePLA foam may be formed into either a flat sheet or a shaped sheet during the molding process and at least one layer of PU foam may be directly adhered to a surface of the ePLA foam without the use of glue.

A further consequence of the remarkable versatility of ePLA foam molding is the ability to form the ePLA foam article into a shape capable of integration within a PU pouring mold. PU may then be formed by pouring uncured liquid into the pouring mold directly on top of the ePLA foam article followed by curing the liquid into PU foam that is already affixed to the ePLA foam article. The result is a hybrid foam article having a robust adhesion between layers but without the use of a separate adhesive material. High volume applications with highly specific shapes, such as automobile headrests, seating, and arm rests, bus or train seating, and office chair cushions could benefit from the use of the hybrid foams described herein. Such foams are easier to produce at lower cost and with superior performance over pure PU foam.

The ability to mold ePLA foam into specific shapes, to modify the shape after molding via thermoforming, and to form an ePLA foam article for integration into a PU pouring mold represents a dramatic improvement over other hybrid foams, such as EVA-PU hybrid foams. EVA foam is typically available in the form of sheets having thicknesses of from about 0.25 inches to about 1 inch, with the thicker EVA foam sheets requiring specialized techniques or equipment to form. Thus, forming a hybrid foam article from EVA foam and PU foam of a specific shape typically requires forming the PU foam into that shape and then applying sheets of EVA foam with an adhesive.

### Hybrid Foam Articles

In one aspect, hybrid foam articles are described herein that include at least one layer of polyurethane (PU) foam and at least one layer of expandable polylactic acid (ePLA) foam. By forming the hybrid foam article from ePLA and PU foam, the hybrid foam article is 20-65% lighter in weight, 15-50% lower in cost, partially biobased, biodegradable under ASTM D5511, and compostable under ASTM D6400, and equivalent or superior in impact performance. The ePLA foam is also capable of being thermoformed, adhered to other materials such as the PU foam without the use of additional adhesive, and molded into a wide variety of shapes, as described above.

In some embodiments, the at least one layer of PU foam has a density of from about 2 lb/ft³ to about 30 lb/ft³ and the at least one layer of ePLA foam has a density of from about 1 lb/ft³ to about 3 lb/ft³. PU foam, such as the PU foam used on furniture applications, may have a density between about 2.2 to about 6 lbs/ft³ and viscoelastic “memory foam” may have a density of about 15 lbs/ft³ or greater.

In some embodiments, the hybrid foam article includes at least two layers of ePLA foam such that the at least one layer of PU foam is disposed in between the at least two layers of ePLA foam. In other words, the at least one layer of PU foam is disposed on a first surface of a first layer of ePLA foam and a second layer of ePLA foam is disposed on an exposed surface of the at least one layer of PU foam.

In some embodiments, the hybrid foam article includes at least one supplemental layer. The supplemental layer may include a layer of viscoelastic foam, EVA foam, expandable polypropylene (EPP) foam, or the like.

In some embodiments, the hybrid foam article includes one or more voids in the at least one layer of ePLA foam. In some embodiments, at least one spring is disposed in one of the one or more voids. Some articles typically formed from PU foam, such as automobile seats, include steel springs to provide the desired cushion characteristics and experience for the occupants of the automobile. Improving the automobile seat with the hybrid foam article as described herein may similarly involve the incorporation of springs into voids.

Automobile seating formed from a hybrid foam article of ePLA and PU foam advantageously reduces the weight of the seat compared to conventional seating, enabling increased mileage efficiency. However, this seating may have challenges with fire retardancy. The fire retardancy can be addressed with the composite formation itself by, for example, inserting the ePLA foam article at the very center of the hybrid article with fire retardant PU foam covering the ePLA layer. The entire hybrid article is therefore able to pass the flame retardancy standard.

Producing transportation seating involves a high volume of identical products. This enables the use of cast PU foam to reduce the labor associated with laminating sheets and assembly. According to Euro Molders (Association for Molded Polyurethane Parts for Automotive Industry), cars have on average 20 pounds of PU foam used in seats and headrest. Automobiles typically use PU foam with a density of 1-3 lb/ft³. By utilizing the hybrid foam articles described herein, about half of the PU foam can be replaced with ePLA for support foams and transition layers. Alternatively, manufacturers tied to CAFÉ standards can achieve a luxury feel by replacing PU foam with ePLA foam with a layer of lighter and compressible PU foam topped with viscoelastic PU foam.

Automobile armrests with leather, vinyl, faux leather, and foam layers are challenging to produce due to their thin shapes. The ability of ePLA to be molded in any desired shape, followed by attachment of PU foam and fabric enables the reduction of labor and resources to form the armrests. If a greater degree of cushioning in the armrest is desired, a different density viscoelastic PU foam can be used. Furthermore, the versatility of ePLA molding enables the formation of voids necessary for incorporating the armrest onto an arm or other securing means for attachment in an automobile.

In some embodiments, the at least one layer of ePLA foam may include two or more ridges. Each ridge may be separated from adjacent ridges by a channel such that one or more voids are formed between the at least one layer of ePLA foam and the at least one layer of PU foam, each void corresponding to a channel. It has been unexpectedly discovered that forming a convoluted surface on the at least one layer of ePLA foam, such as through the formation of ridges separated by channels, can influence the tactile feel of the hybrid foam article without compromising the integrity of the adherence of the PU foam to the ePLA foam. In some applications, such as mattresses, topographical structures may be desired to provide tuned ergonomics. When a mattress is formed from a hybrid foam article having an ePLA foam layer with ridges, a user may lay on the exposed PU surface and feel the PU deform differently or to different degrees in regions disposed over a ridge in the ePLA foam versus regions disposed over a channel in the ePLA foam. Although this embodiment has been described with reference to “ridges” and “channels,” the convoluted surface of the ePLA foam may take the form of curves, lattices, or any other shape and degree of convolution according to the desired ergonomic characteristics of the hybrid foam article.

In some embodiments, the hybrid foam article includes a layer of adhesive or glue in between the at least one layer of PU foam and the at least one layer of ePLA foam. As described above, ePLA foam advantageously adheres to PU foam by simply heating the ePLA foam and pressing the materials together. However, it may be desirable in some circumstances, such as when the surface of the ePLA foam is convoluted so that there is a lower contact surface area between the layers, to include an adhesive to prevent delamination of the layers.

In some embodiments, one of the at least one layer of PU foam includes viscoelastic PU foam, otherwise known as “memory foam.” In some embodiments, one of the at least one layer of PU foam includes gel-infused viscoelastic PU foam. In embodiments with two or more layers of PU foam, one layer may have a first density while another layer may have a second density. One layer of PU foam may have a first region with a first density and a second region with a second density. A first layer of PU foam may be viscoelastic foam while a second layer may be conventional PU foam. In some embodiments, the PU foam includes one or more additives, such as graphite, flame retardants, soybean oil, fillers, or colorants.

In some embodiments, the at least one layer of PU foam has a first region with a first density and a second region with a second density. By adjusting curing parameters after pouring PU into a PU mold, different density regimes can be formed within the layer of PU foam.

In some embodiments the hybrid article has a sound transmission class (STC) of about 68 per inch of article thickness. The STC is a measure of the sound blocking/absorption properties of a material and is calculated by generating a sound on one side of a piece of a material and measuring how much sound is “heard” or detected on the other side of the material. ASTM E90-61T is the standard test for measuring the STC of a material. The STC of a material is most directly related to the mass of the material; increasing the mass either through the addition of heavier materials or the addition of thickness is the simplest means by which to increase the STC. An STC of 60 or greater is considered adequate soundproofing in a hypothetical room formed from the material. It has been unexpectedly discovered that forming the hybrid foam articles from at least one layer of ePLA foam and at least one layer of PU foam results in an article with superior sound dampening properties compared to PU foam alone having the same dimensions, despite the substantial reduction in weight. Open cell spray foam formed from PU foam has an STC of from about 40 to about 50.

In some embodiments, the hybrid foam article has a layer of fabric adhered to a surface of the article. The adhesion may be performed as described in U.S. patent application Ser. No. 18/477,183 to Lifoam Industries, LLC, or it may be achieved through the application of an adhesive material. The ability to quickly and easily adhere a layer of fabric to the hybrid foam article is critical in applications such as furniture making, automobile seats, office chairs, and the like.

In some embodiments, the hybrid foam is in the form of a cushion for use in applications such as wheelchairs, automobile chairs, headrests, or armrests, and the like. In such applications, it is desirable for the user to feel a compression of the foam article without feeling the foam “bottom out.” In other words, when the PU foam has been fully compressed, it is desirable for a user to feel at least some additional compression with the application of further force. If the article is formed from PU foam alone, the thickness must be great enough to prevent this bottoming-out phenomenon. By replacing at least some of the PU foam with a layer of ePLA foam, the layer of PU foam may be fully compressed without the subsequent feeling of “bottoming out.”

In the case of chairback foam and some of the slimmer seat foams, typical commercial applications involve adhering softer PU foam on top of a machined or thermoformed EVA foam. The EVA foam provides the shape of the seat while the glued PU foam layer follows the EVA foam shape to form curvature at the sides of chairs. The process of shaping EVA is expensive while creating waste and dust. Attaching PU foam to a curved EVA foam also requires manual work and creates high yield loss. When comparing flexible PU foam adhered to much denser EVA backing in application of chair backs and seats, the weight reduction benefit of ePLA molded articles is substantial. Compared to higher density closed cell EVA laminated with open cell PU foam, ePLA panels enable weight reduction of 50% or more. In specific cases where very thin EVA foam sheets are used, the benefit may be 20-35% for the entire hybrid article. Producing lighter chairs without sacrificing stiffness is a desirable combination.

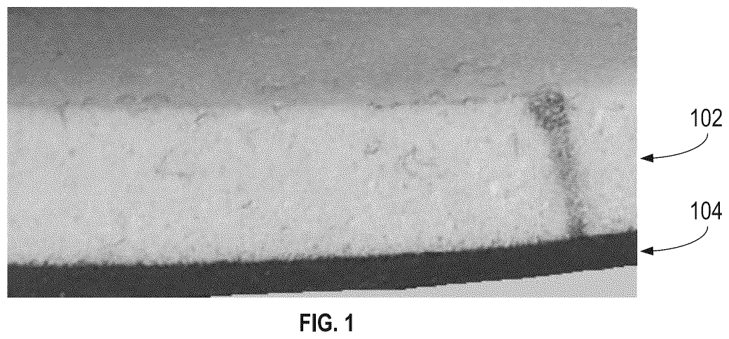

Cushions on personal mobility devices such as wheelchairs and scooters typically make use of hybrid articles combining EVA foam as a stiffer support foam with combinations of viscoelastic PU foam and flexible PU foam. These applications require balancing comfort, weight, and ease of getting out of the seat; this balance involves designing chair-back and chair-base foam with a thickness ranging from 1″ to 4″ and resembles the laminate depicted in FIG. 1, which includes PU foam layer 102 and EVA layer 104. The density of the hybrid article in these conventional solutions ranges between 5 lb/ft³ to 15 lb/ft³. Manufacturers seeking to reduce the weight of these solutions turn to more expensive but lighter frame materials made with aluminum and carbon fiber. The hybrid ePLA and PU foam articles described herein have the ability to reduce the weight of the chair-back cushion and the chair-base cushion by 1-3 lbs in devices such as wheelchairs enabling even lighter mobility devices and/or the ability to use lower cost frame materials. In powered personal mobility devices, the reduced weight also improves battery life and efficiency.

For chair manufacturers desiring to maintain chair weight while producing chairs with more luxurious feel, viscoelastic PU foam (memory foam) can be used with ePLA. This leads to a plush chair with similar support as the PU-PU hybrid articles. The viscoelastic PU foams are typically much higher in density than flexible PU foam but are preferred by users due to their softness. Gel-infused memory foam (subcategory of viscoelastic foam) can be attached similarly. This combination allows manufacturers to achieve luxury feel without increasing the overall chair weight with standard PU foam.

Traditional office chairs are often being replaced with ergonomic chairs. The majority of new ergonomic chairs being produced focus on a neutral posture that promotes blood flow to the user's feet. Shaped chairs such as saddle chairs, saddle stools, swopper chairs, and kneeling chairs are becoming more common in medical and service industries. Unlike traditional office chairs, these chairs are uniquely-shaped and therefore cost substantially more than traditional chairs. The ability to easily shape and personalize chairs using ePLA can address the rising demand and cost of these ergonomic chairs. A chair which improves blood flow, improves posture, is easy to produce, and is customized to a specific user is achievable using the hybrid foam articles described herein through thermoforming ePLA and easy adhesion of PU foam.

The benefits in office chair seating realized by the hybrid foam articles described herein may also be realized in transportation seating, medical seating, sofas, or other seating applications. For example, bariatric chairs realize significant weight reductions without compromise performance. Seating in transportation such as buses or airplanes have an additional concern relating to carbon emissions which may be reduced by the substantial weight reductions possible with the hybrid foam articles of the present invention.

In another aspect, a mattress is claimed that includes at least one layer of PU foam and at least one layer of ePLA foam, as described herein. Typical mattresses include one or more layers of PU foam and other materials having a density ranging from about 3 lb/ft³ to about 5 lb/ft³. The layers of typical mattresses that are proximal to the user are usually higher density PU foam and have a thickness of from about 2 to about 3 inches. The remaining layers of the mattress usually accounts for 40-80% of the overall volume and are designed to reach the desired size; these layers don't usually factor substantially into the comfort of the mattress. In some embodiments, a mattress formed from the hybrid foam described herein resembles a typical mattress but with an ePLA foam layer instead of the less dense middle and bottom layers. The mattress described herein therefore has a weight of only about 28 to about 103 pounds, compared to typical mattresses that range from 50 to 200 pounds, depending on the mattress size. Furthermore, springs may be incorporated as described herein.

Innerspring mattresses with coils involve tying the coils to each other to keep them in place. This tying results in transferring motion from one part of the mattress to the other. ePLA offers an advantage where instead of tying springs, each spring can reside in an individual ePLA pocket. As the springs are no longer tied, movement on the mattress is isolated. The process of incorporating pockets is lower cost and eliminates the materials, time, and labor associated with tying the springs together. The molded pockets within the ePLA foam layer can have additional functions such as acting as a path for incorporating a cooling or heating medium. Furthermore, just replacing the dense support foam with ePLA with defined through holes can improve breathability of the mattress.

Memory foam mattresses do not have springs but rely on different layers of PU foam to provide support. These mattresses are heavier as a result. Swapping the support PU foam layer with ePLA foam reduces the weight of the mattress while maintaining performance.

Convoluted foam topped mattresses are common in premium mattresses and are known for their ability to help with blood flow. The convoluted shapes are limited due to the shearing machine which splits a polyurethane foam layer into two geometrically matching shapes. By shape molding a hybrid foam article as described herein, the ePLA layer would impact features similar to that of convoluted PU. ePLA can be shaped into any shape and is not restricted to the ability of the shearing machine. Furthermore, egg crates, ridges, pins, columns, and/or wedges can be incorporated in the same mattress with no extra steps. This further enables the ability to form shapes which do not have a corresponding negative shape. The convoluted features help with air circulation around the surface touching the mattress as well increase blood circulation from the small pressure points created from the convoluted features.

ePLA can provide extra support at edges of mattresses to further customize the experience, such as by making it easier for a user to stand or get off of the mattress. The shaped ePLA layer can incorporate features to help with blood flow only where it is most needed such as middle of the body. It can allow for shaped mattresses with a cavity or other varied topography for the user's legs or to raise part of body. Lumbar support and selective stiffening can be incorporated easily in the molded ePLA support layer. Since the PU foam layer remains in sheet form, this approach to mattress customization results in no additional waste and it reduces mattress manufacturing steps. Furthermore, the ePLA foam layer can include corner and edge protection, increasing the life of the mattress. Edge support is a key feature in premium mattresses and are responsible for less sagging and support drop-off towards the edge.

Latex foam topped mattresses are even heavier than PU foam mattresses because latex rubber is heavier. Replacing the support layer in latex-based mattresses with a layer of ePLA is even more beneficial in reducing weight.

### Other Applications

The hybrid foam articles described herein may also be implemented in antifatigue mats with limited use life. Typical antifatigue mats are heavy and challenging to clean. Incorporating ePLA with a cast PU foam surface or a closed cell viscoelastic PU foam sheet results in easy to clean, lightweight mats. The ability to incorporate shaped ePLA can add additional benefits such as the ability to lock the mat to features in the floor or adding features which improve blood circulation in feet. These mats can be for industrial settings, kitchens, gyms, schools, hockey rinks, bath mats, hospitals and commercial settings.

Pet beds made with ePLA and PU foam where the ePLA is shaped or has ventilation holes enables weight reduction and the ability to be compostable. The hybrid article may also involve adhesion of the layers using discrete adhesion points, enabling easier separation of the ePLA and the PU foam. In addition, these beds can be easier to clean and safer for pets opposite other ecofriendly pet bed options.

Acoustic management within commercial buildings and at home is an application with growing attention and popularity. Acoustic management involves acoustic absorbers and acoustic diffusers. Low density, open cell polyurethane is extremely useful in these applications. However, the low-density open cell polyurethane foam has low modulus and high flexibility preventing them from being used without some sort of structural support. The ability to adhere the low density, open cell polyurethane foam on top of shaped ePLA foam offers an incredible opportunity for easy to manufacture and lightweight sound dampening solutions. These articles can produce novel shapes with unique angles.

Polyurethane foam is often used in storage for valuables and guns. The soft, open cell or mostly open cell foam allows the gun or valuables to reside deeper in the cavities or in between two layers of this foam. Combining shaped ePLA foam as a base allows easier formation of cavities in the open cell foam.

### Methods of Forming Hybrid Foam Articles

In another aspect, methods of forming hybrid foam articles are described herein that include molding a plurality of expandable foam beads comprising polylactic acid into a first layer of expandable polylactic acid (ePLA) foam having a first shape, and forming at least one layer of polyurethane (PU) foam on a surface of the first layer of ePLA foam to form the hybrid foam article. By forming the at least one layer of PU foam on the surface of the ePLA foam having the first shape, the resulting hybrid foam article has the first shape.

Conventional methods of forming hybrid foams that include a PU foam layer and an EVA foam layer include a machined layer of EVA, which involved substantial waste and dust production. Such methods also rely exclusively on an adhesive for securing the PU foam to the EVA.

In some embodiments, forming the at least one layer of PU foam includes adhering the layer of PU foam to the first layer of ePLA foam. In some embodiments, adhering the layer of PU foam to the first layer of ePLA foam includes heating the surface of the ePLA foam and pressing the layer of PU foam against the surface to effect the adhesion. In some embodiments, adhering the layer of PU foam to the first layer of ePLA foam includes applying an adhesive to the surface of the ePLA foam.

In some embodiments, forming the at least one layer of PU foam includes placing the first layer of ePLA foam in a pour mold, pouring liquid A-B polyurethane mixture on top of the ePLA foam, and curing the A-B polyurethane mixture to form the layer of PU foam. By placing the ePLA foam into a pour mold, it's possible to cover the entire exposed surface of the ePLA foam in PU mixture. Thus, in some embodiments, the layer of PU foam contacts at least three sides of the first layer of ePLA foam.

In some embodiments, the first layer ePLA foam is in a first shape that is substantially flat before applying the PU foam to the surface of the ePLA foam. In some embodiments, the hybrid foam article is thermoformed from the first shape to a second shape. As described in U.S. patent application Ser. No. 18/191,422 by Lifoam Industries, LLC, ePLA foam articles are readily thermoformed, so the hybrid foam articles of the present invention are capable of being thermoformed into a wide variety of second shapes which may be unfeasible to form in the first instance. In other words, by forming the first layer of ePLA into a substantially flat layer and forming the layer of PU foam on the first layer of ePLA, which may be performed with minimal complexity, the desired final shape for the hybrid foam article may be achieved through thermoforming of the hybrid foam article.

### EXAMPLES

### Example 1: Forming Flat Hybrid Foam Article with Adhesive

Super 77™ spray adhesive, available commercially from 3M Company, Saint Paul, Minnesota, United States, was used to attach two types of polyurethane foam onto ePLA panels. Super 77™ adhesive is also used in conventional PU-PU hybrid articles. Upon spraying on a 1″ thick ePLA panel, the Super 77 left a sticky residue but did not corrode the foam. A minimal force (less than 5 psi) was used to stretch and attach a 1″ thick polyurethane foam sheet resulting in a hybrid article of ePLA and PU foam. The resulting ePLA-flexible PU foam laminate closely rivals a rigid PU-flexible PU foam laminate. Both have good bonding and similar compression response. However, replacing rigid PU foam with ePLA can reduce the weight of the rigid component by 50-75%. This is an overall weight savings of 30-40% when comparing hybrid articles of the same thickness.

### Example 2: Mechanical Property Comparison

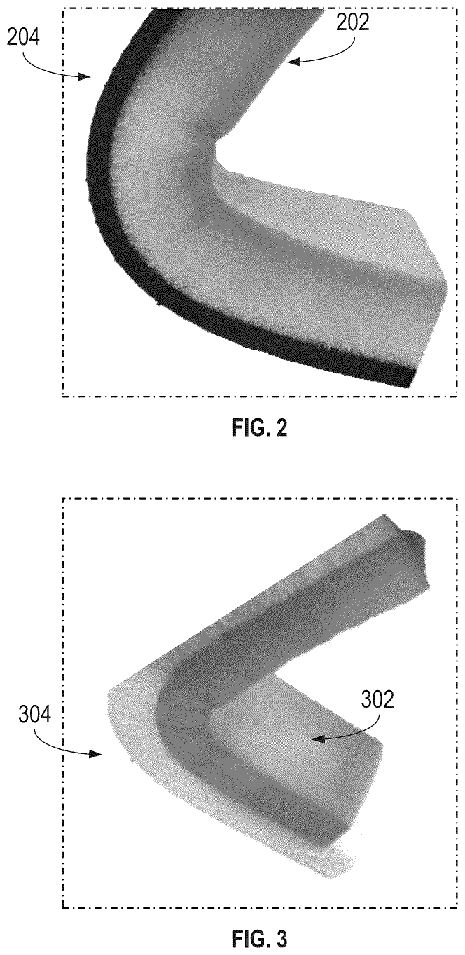

A first article was formed having a 1″ PU foam layer and a 0.25″ EVA foam layer, for an overall thickness of 1.25″. This first article is depicted in FIG. 2, showing the PU layer 202 and EVA layer 204. A second article was formed having 0.625″ PU foam layer and 0.625″ ePLA foam layer, for an overall thickness of 1.25″. This second article is depicted in FIG. 3, showing the PU layer 302 and ePLA layer 304. Both articles were bent and both were capable of full recovery from the deflection position. However, the second article with the ePLA foam layer is lighter and relies on a thinner PU foam layer.

### Example 3: Three-Layer Hybrid Foam Article

In general, manufacturers are balancing cost, functionality, and the tactile feel of foams in seat cushions by measuring a parameter of foam known as either indention load deflection (ILD) or indention force deflection (IFD). Low ILD/IFD results in a foam “bottoming out,” which is undesirable, while high ILD/IFD results in foam which feel hard. An ideal cushion would involve a laminate which does not “bottom out” and feels soft to both touch and seating. These competing needs lead to the formation of a three-layer laminate composed of rigid foam, flexible foam, and viscoelastic foam.

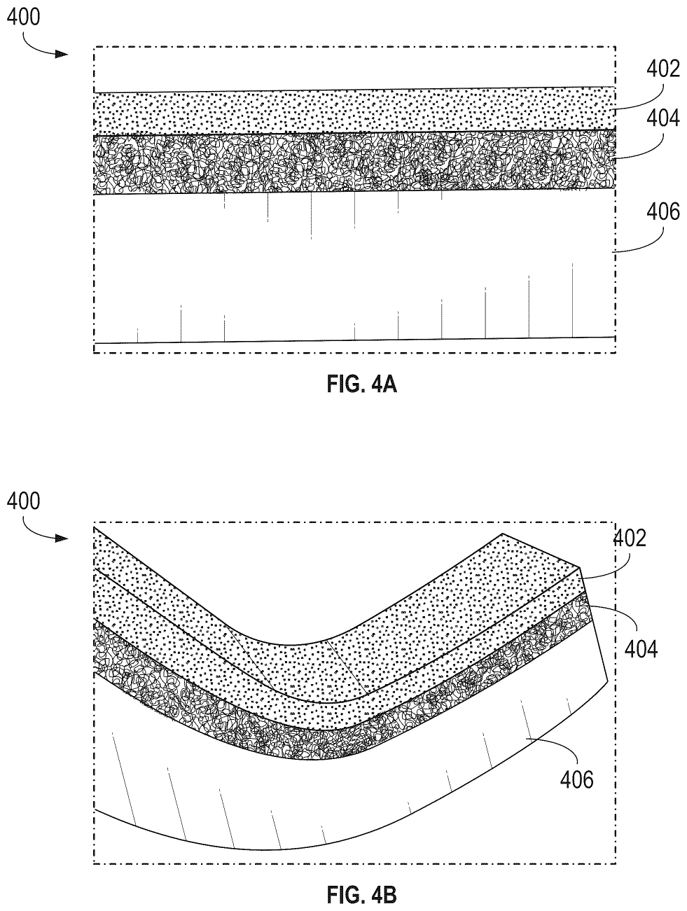

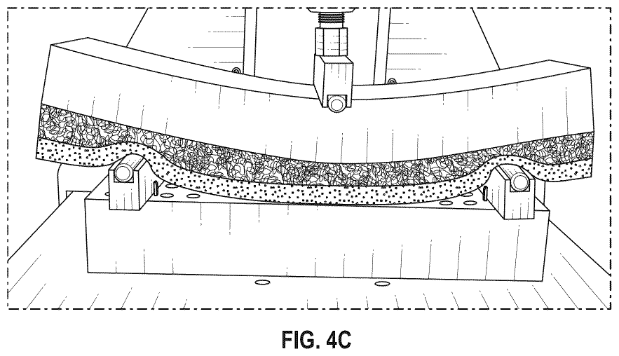

A three-layer hybrid foam article was formed having a 0.5″ thick layer of viscoelastic (memory foam) PU foam, a 0.5″ thick layer of lightweight PU foam, and a 1.5″ thick layer of molded ePLA foam, with the layers joined by Super 77™ adhesive. This article is depicted in FIG. 4A, which depicts the hybrid foam article 400 with the viscoelastic PU foam layer 402, lightweight PU foam layer 404, and ePLA layer 406.

The three-layer hybrid foam article was subject to a 3-point bend test, as depicted in FIG. 4B. In this test, the article was subject to a force of 45 lbs. As shown in FIG. 4B, the ePLA layer experienced no deflection and the two PU foam layers do not “bottom out.” If incorporated into a cushion, for example, a user would not feel the ePLA layer in use. After the 3-point bend test, the three-layer hybrid article remains securely adhered together without any fracturing in the layers, as shown in FIG. 4C.

### Example 4: Improving Manufacturing of Foam Seating

Conventional furniture manufacturing involves attaching PU foam to a shaped wooden base followed by stretching fabric over the PU and securing it to the wooden base. The fabric attachment can be with staples or adhesive. In the hybrid foam articles described herein, the process of attaching fabric is simplified because the fabric can adhere directly to the ePLA molded article, eliminating the need to use a wooden base. As described herein, the ePLA foam layer is simple to machine and produces no dust. The fabric can be a polyester fabric, cotton fabric, other fabric, vinyl, faux leather, or leather.

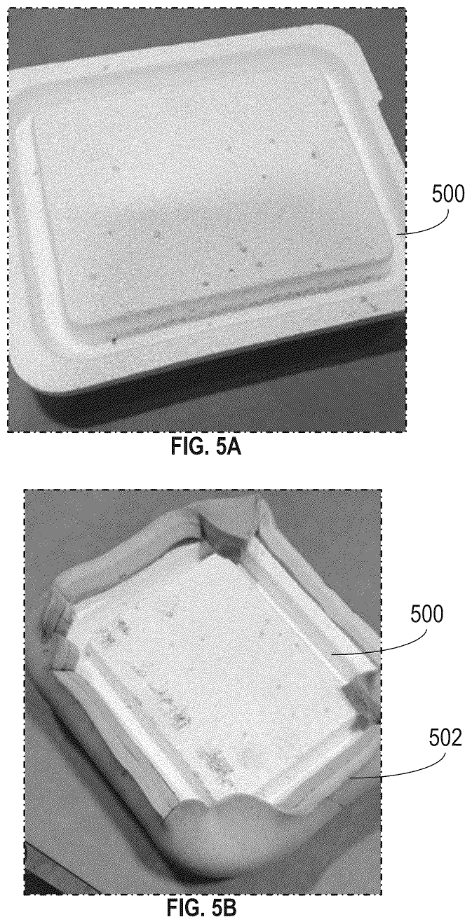

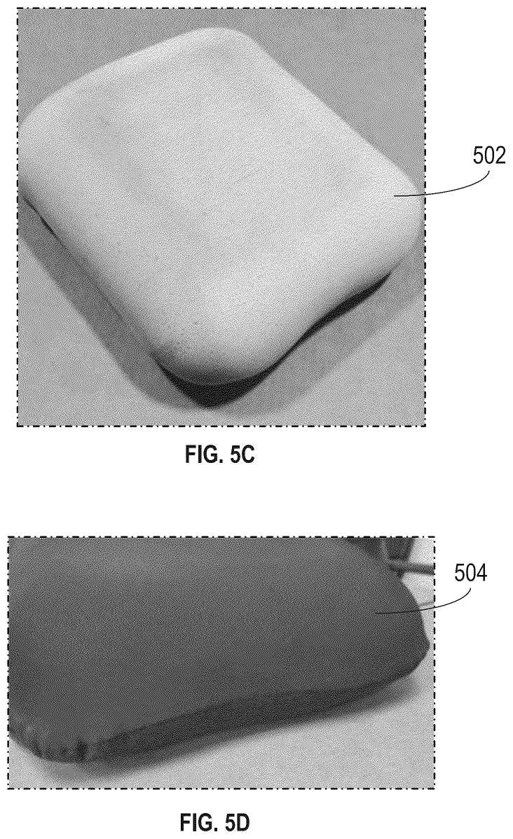

A molded ePLA foam layer was produced and a 1″ thick viscoelastic PU foam layer was attached using Super 77™ adhesive. A breathable cotton fabric was stretched over the viscoelastic PU foam and attached exclusively to the ePLA material using only heat to adhere the fabric to the ePLA foam. FIG. 5A depicts the ePLA foam layer 500. FIGS. 5B and 5C depict the ePLA foam layer 500 with a layer of PU foam 502 attached. FIG. 5D depicts a layer of cotton fabric 504 stretched over the layer of PU foam 502. This hybrid foam article with fabric layer was performed with less effort than conventional furniture manufacturing and with less dust production.

### Example 5: Forming Hybrid Foam Article Out of Orthopedic PU Foam

A 6 lb/ft³ layer of PU foam used for orthopedic pads, mattresses, and pillows (Smooth-On FlexFoam-iT!™ 6 Pillow Soft, available commercially from Smooth-On, Inc., Macungie, Pennsylvania, United States) was applied on top of a layer of ePLA foam. A 2″ thick hybrid article with a length and width of 11″ was formed with a 1.5″ thick layer of ePLA foam and a 0.5″ thick layer of the 6 lb/ft³ PU foam. The hybrid article weighed 0.4 pounds. A comparable PU foam article would have weighed 0.8 pounds. This represents a 50% reduction in weight with no change to the indention force deflection. The PU foam, when compressed, does not “bottom out” against the ePLA foam plank.

### Example 6: Forming Hybrid Foam Article Via Pouring PU

An ePLA foam layer was placed in a pour mold and liquid A-B polyurethane mixture was poured on top of the ePLA. After curing, a layer of fabric was stretched over the PU foam and adhered to the ePLA using only heat to effectuate the adhesion. As a result, a hybrid foam article is formed without any adhesive; the cured PU foam layer is adhered to the ePLA foam as a result of the curing process.

### Example 7: Analysis of Mattress Improvements

Mattresses represent the largest use of PU foam and therefore represent the largest contributor to PU waste in landfills. The hybrid foam articles described herein not only improve the carbon footprint associated with production and waste, they offer unique benefits not possible with traditional mattresses. The ePLA foam portion can be separated and composted. Alternatively, the ePLA portion degrades in a bioactive landfill in less than 18 months.

A typical mattress is comprised of PU foam and other materials with an average density range between about 3 to about 5 or more lb/ft³. The materials which form the top layers of a mattress are the higher density foams at about 3.5 to about 5 or more lb/ft³. These denser PU foams have longer lifespans, are more durable, and provide greater comfort to the user. The middle and bottom sections of the mattress make up 40-80% of the volume and are mostly used to build up the mattress in size and thickness. According to Amerisleep and Casper, the average thickness of mattresses ranges between 8 to 14 inches. Superior mattresses should have a comfort layer that's at least 2-3 inches thick and a base layer that's at least 6-8 inches thick. Most mattresses also contain a 1-2 inch thick transition layer.

The hybrid foam articles described herein would replace the dense support foam (middle and bottom layers) with an ePLA foam layer. This would reduce the weight of mattresses ranging from 50 to 200 pounds down to 28 to 103 pounds depending on the mattress size as shown in Table 1:

TABLE 1
Analysis of Mattress Weights

| | | | | | Mattress with ePLA | | | |
|---|---|---|---|---|---|---|---|---|
| | | Premium | All Polyurethane | | Support | | | |
| | Mattress | Mattress | Weight | Weight | Weight | Weight | | |
| | Volume | Volume | for | for | for | for | Weight | |
| Size | (cuft) | (cuft) | Standard | Premium | Standard | Premium | Reduction | |
| Twin | 13.2 | 23.1 | 54 | 92 | 28 | 48 | 49% | 48% |
| Full | 18.4 | 32.2 | 75 | 129 | 39 | 68 | 49% | 48% |
| King | 28.1 | 49.3 | 115 | 197 | 59 | 103 | 49% | 48% |

### Example 6: Covering ePLA with PU Layer

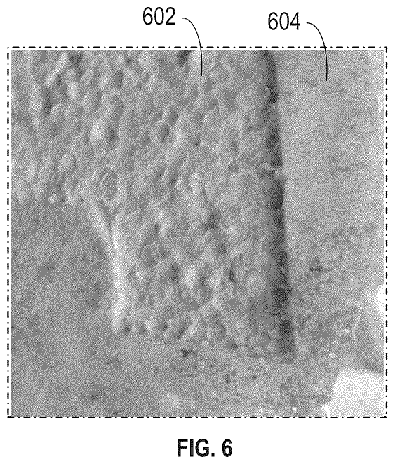

An A-B polyurethane mix (Smooth-On FlexFoam-iT!™ 6 Pillow Soft) was prepared and poured around a molded ePLA article. The result is depicted in FIG. 6, which depicts an ePLA layer 602 having an “L” shape that is surrounded by the cured PU foam layer 604. The PU foam exhibits remarkably strong adhesion to the ePLA and is presented to the user as a hybrid foam article with at least three sides covered with PU foam. However, the “core” of the article is ePLA, resulting in an article that is lighter and having an increased stiffness than PU foam alone.

### Example 7: Attaching PU Foam to Shaped ePLA Layer

Unlike traditional convoluted foam mattresses where only the top layer is convoluted, incorporating an ePLA base layer having a shaped or convoluted surface allows the shape to influence the uppermost PU layer of the mattress.

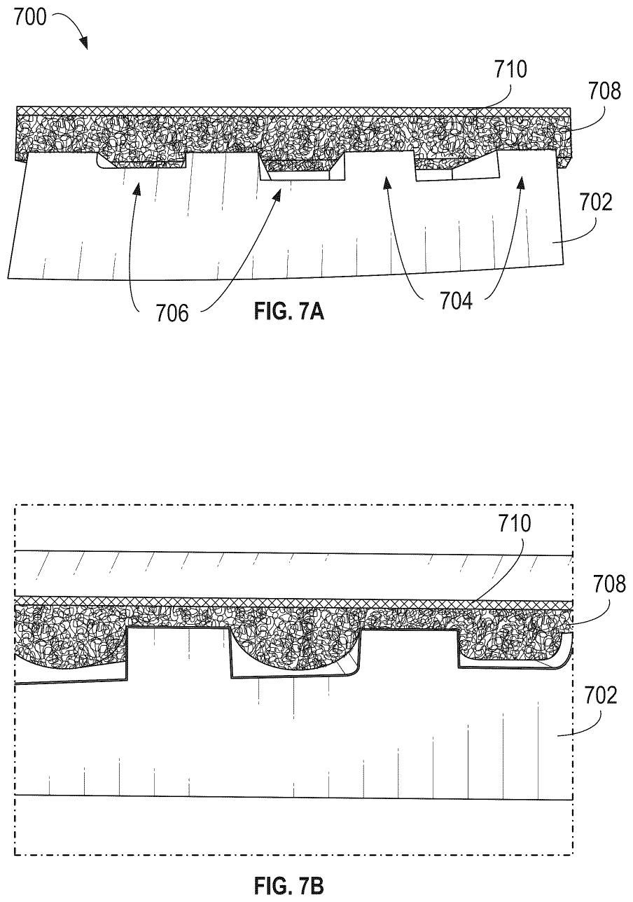

A hybrid article was prepared from a 1″ thick flexible PU foam layer topped with 0.125″ thick viscoelastic PU foam. This stack was attached to an ePLA molded article with machined ridges using heat to adhere the layers. The ridges have a depth between 0.25 and 0.5″. The result is depicted in FIGS. 7A-7B. In FIGS. 7A-7B, the hybrid foam article 700 includes ePLA layer 702 having ridges 704 and channels 706. A layer of flexible PU foam 708 is adhered to the ridges 704 and a layer of viscoelastic PU foam 710 is adhered to the top of the flexible PU foam 708.

This example shows another alternative to attaching PU foam to ePLA; previous examples have focused on either an adhesive such as Super 77™ or pouring PU foam and curing it in contact with an ePLA layer. Direct heating of the ePLA and polyurethane layers and bringing the layers together results in a robust bond, a property that ePLA is uniquely capable of achieving with impressive consistency and success. This method eliminates glue such as Super 77™ and avoids A-B mix which require controls and safety.

FIG. 7B depicts the article in FIG. 7A with a 20 lb weight pressing against the PU layers. The PU foam does not “bottom out,” although the user-facing PU foam exhibits different levels of deformation and stiffness depending on whether the underlaying layer of ePLA has a ridge or a channel.

### Example 8: Forming Rigid PU Foam on ePLA Foam

Rigid PU foam is often used as insulating media and is available in panels or poured in custom shapes. The rigid PU panels suffer from brittleness resulting in cracked edges and sides. These cracks result in air gaps and leak points when installed. Encapsulating the rigid but brittle PU foam in ePLA compensates for the brittleness of the PU foam, resulting in a hybrid foam article with strength closer to the ePLA foam. The ability of ePLA to readily adhere and attach to other substrates results in a more useful product.

Unlike corrugate which results in the collapse of rigid PU foam cells, cells produced in rigid PU next to ePLA are the same as bulk cells in the middle of the PU foam. This surprising result shows the ability to reduce the weight and density variation in creating this hybrid foam composite.

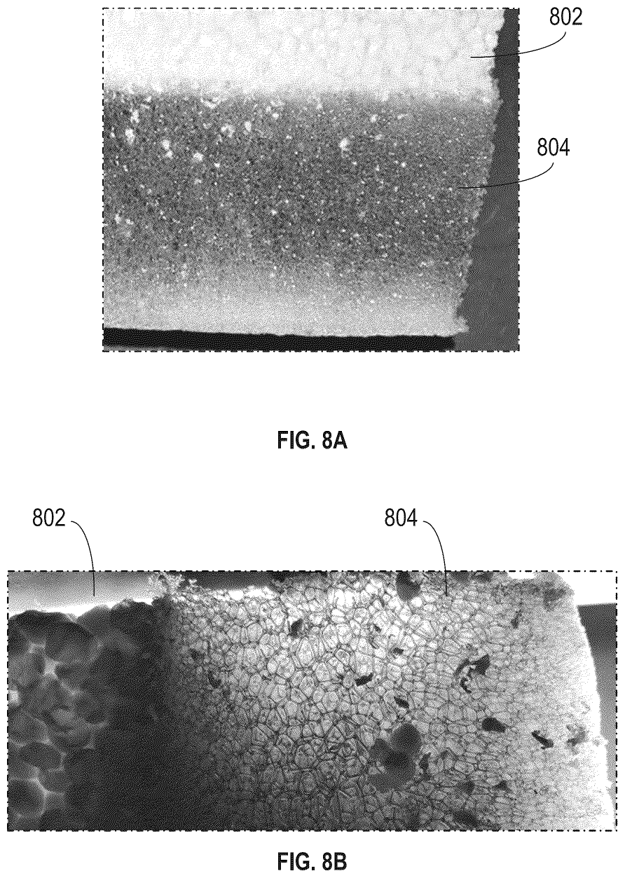

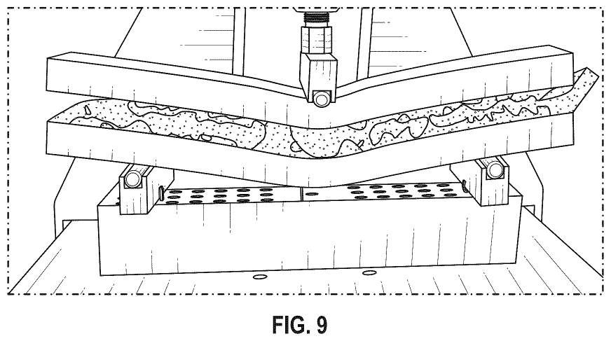

A rigid PU foam mix, Sika® PostFix® Fence Post Mix available commercially from Sika Corporation, Lyndhurst, New Jersey, United States, was prepared according to the manufacturers instructions and poured directly onto molded ePLA foam panels. The same was cut with a knife to reveal the foam structure. This article is depicted in FIGS. 8A and 8B, which shows the ePLA layer 802 and PU foam layer 804.

Accounting for minor debris from the cutting process, the cells in the PU foam formed proximal to the ePLA panel show little to no densification or collapse. In contrast, the cells at the edge of the PU foam opposite to the ePLA foam panel are smaller, denser, and collapsed. FIG. 8B depicts this article with an illumination source passing through the cells. Greater light transmission corresponds to increased cell size and lower densification.

It was unexpectedly discovered that attempts to separate the rigid PU foam and the ePLA foam results in breakage of the ePLA foam rather than any failure at the interface between the layers.

One benefit of ePLA and rigid polyurethane foam hybrid articles is a weight reduction in insulation panels and pallet shippers. The benefits of improved sealing surfaces for panels and pallet shipper are expected to result in improvements in overall thermal performance. Other benefits such as faster cure times for thinner polyurethane layers and reduced thermal performance upon aging polyurethane are expected.

By replacing half of the rigid polyurethane layer and avoiding collapsed cells at interface, an existing 2.5-3.2 lb/ft³ PU foam article can experience a density reduction to 1.5 lb/ft³, representing a 40-55% reduction in weight with improved overall thermal performance.

### Example 9: Rigid PU Foam Spray Between Two ePLA Panels

Great Stuff™ spray foam sealant, a rigid PU foam spray available commercially from DuPont de Nemours, Inc., Wilmington, Delaware, United States, was sprayed between two ½″ panels of ePLA to produce a 1½″ hybrid article. Three separate identical articles were produced and tested under identical conditions. One of these articles is depicted in FIG. 9. Without the PU foam spray, each individual ePLA panel has a flexural strength of 31 psi flexural strength compared to 47 psi for the hybrid foam article. The flexural strength increase is observed without a reduction in deflection-to-break as a deflection of 0.84″ was reached in a three-point test, depicted in FIG. 9. This hybrid foam article therefore combines both the flexibility and elasticity of ePLA with the strength of rigid PU foam. During deflection tests, failure of the article was only observed once the inner PU inside failed, thus resulting in both materials failing at the same time. This is unexpected because of the large number of observed voids in polyurethane caused by inconsistent delivery of polyurethane from spray in creating the hybrid article. It is expected that a uniform rigid PU foam application will increase the flexural strength further. All three of the prepared articles exhibited the same flexural strength and deflection.

### Example 10: Attaching Low Density PU Foam to ePLA

A block of ePLA foam was pressed against a heated platen at 375° F. for a few seconds before a piece of 2 lb-density PU foam was pressed and wrapped onto the foam. After cooling and allowing the ePLA and PU to adhere to one another, the PU foam was removed from the ePLA to test the level of adhesion. After being removed, the PU foam was torn leaving a PU foam residue on the surface of the ePLA. This demonstrates the remarkably strong bond realized by simply heating the ePLA foam and pressing the layers together without using a separate adhesive.

A second hybrid article including low density PU foam sample was prepared. A sample of 1″ thick 2 lb-density PU foam with a ¼″ EVA foam backing was attached to a 3″ block of ePLA foam. The top surface of the ePLA foam block was heated on a heated platen at 375° F. for a few seconds before the low density polyurethane foam was pressed onto the top surface so that the polyurethane surface was in contact with the ePLA surface. After pressing down across the surface, the level of adhesion was checked. There was a strong bonding across the surface and even in the edges where the foam had a slope, the polyurethane foam followed the slope. This indicates that not only can a strong bond be achieved without the use of adhesive, the bond and method is robust enough that when the polyurethane foam is applied, it can follow the shape of the ePLA surface to which it is adhered.

### Example 11: Attaching Low Density PU Foam to Ridged ePLA

A sample of 1″ thick 2 lb density PU foam with ¼″ EVA foam backing was attached to a 3″ block of ePLA foam which had 2″ wide ridges separated by 2″ wide channels having a depth of 1″. This article is depicted in FIG. 7A. Despite only half of the ePLA surface being in contact with and attached to the PU foam, the adhesion was strong enough that the PU foam could flex and compress into the channels without separating from the ridges in the ePLA foam. A heavy metal weight was placed on top of the polyurethane foam to illustrate how the foam would provide greater deflection in some areas rather than others. This deflection is illustrated in FIG. 7B. By providing greater deflection in some areas, foam support can be customized depending on the application. For example, a shoe application may involve greater compressive resistance around the heel, ball, and less around the arch. Throughout the tests, the polyurethane foam did not separate from the ePLA foam.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single element, but the corresponding description should be read to include embodiments of two or more elements. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. A hybrid foam article comprising at least one layer of polyurethane foam and at least one layer of expandable polylactic acid (ePLA) foam.

2. The hybrid foam article of claim 1, wherein the at least one layer of polyurethane foam has a density of from about 2 lb/ft³ to about 30 lb/ft³, the at least one layer of ePLA foam has a density of from about 1 lb/ft³ to about 3 lb/ft³.

3. The hybrid foam article of claim 1 comprising at least two layers of ePLA foam, wherein the at least one layer of polyurethane foam is disposed on a first surface of a first layer of ePLA foam, and a second layer of ePLA foam is disposed on an exposed surface of the at least one layer of polyurethane foam.

4. The hybrid foam article of claim 1, further comprising at least one supplemental layer, wherein the at least one supplemental layer comprises viscoelastic foam, ethylene-vinyl acetate (EVA) foam, or expandable polypropylene (EPP) foam.

5. The hybrid foam article of claim 1, further comprising one or more voids in the at least one layer of ePLA foam.

6. The hybrid foam article of claim 5, further comprising at least one spring disposed in at least one of the one or more voids.

7. The hybrid foam article of claim 1, further comprising two or more ridges in the at least one layer of ePLA foam, each ridge in the two or more ridges separated from adjacent ridges by a channel, such that one or more voids are formed between the at least one layer of ePLA foam and the at least one layer of polyurethane foam, each void corresponding to a channel.

8. The hybrid foam article of claim 1, further comprising a layer of glue between the at least one layer of polyurethane foam and the at least one layer of ePLA foam.

9. The hybrid foam article of claim 1, wherein the ePLA foam comprises homopolymers, copolymers, or blends comprising polylactic acid.

10. The hybrid foam article of claim 1, wherein the ePLA comprises one or more additives.

11. The hybrid foam article of claim 1, wherein the polyurethane foam comprises viscoelastic polyurethane foam or gel-infused viscoelastic polyurethane foam.

12. The hybrid foam article of claim 1, wherein the polyurethane foam comprises one or more additives.

13. The hybrid foam article of claim 12, wherein the one or more additives comprise graphite, flame retardants, soybean oil, fillers, or colorants.

14. The hybrid foam article of claim 1, wherein the at least one layer of polyurethane foam has at a first region with a first density and a second region with a second density.

15. The hybrid foam article of claim 1, wherein the hybrid foam article has a sound transmission class (STC) of 68 per inch of article thickness.

16. The hybrid foam article of claim 1, further comprising a layer of fabric adhered to the hybrid foam article.

17. The hybrid foam article of claim 1, wherein the hybrid foam article is in the form of a cushion for use in a wheelchair or automobile headrest.

18. A mattress comprising at least one layer of polyurethane foam and at least one layer of expandable polylactic acid (ePLA) foam.

19. A method of forming a hybrid foam article, the method comprising:
molding a plurality of expandable foam beads comprising polylactic acid into a first layer of expandable polylactic acid (ePLA) foam, the first layer of ePLA foam having a first shape, and
forming at least one layer of polyurethane foam on a surface of the first layer of ePLA foam to form the hybrid foam article, wherein the hybrid foam article has the first shape.

20. The method of claim 19, wherein forming the at least one layer of polyurethane foam comprises adhering the layer of polyurethane foam to the first layer of ePLA foam.

21. The method of claim 19, wherein forming the at least one layer of polyurethane foam comprises:
placing the first layer of ePLA foam in a pour mold,
pouring liquid A-B polyurethane mixture on top of the first layer of ePLA foam, and
curing the A-B polyurethane mixture into the layer of polyurethane foam.

22. The method of claim 21, wherein the layer of polyurethane foam contacts at least three sides of the first layer of ePLA foam.

23. The method of claim 19, wherein the first shape is substantially flat, and wherein the method further comprises:
thermoforming the hybrid foam article from the first shape to a second shape,
wherein the thermoforming step is performed without any loss of material.
